(19) United States
(12) Patent Application Publication
(10) Pub. No.: US 2015/0186937 A1
(43) Pub. Date: Jul. 2, 2015

(54) OBTAINING ALTERNATIVE KEYWORDS

(71) Applicants: Ka Cheong Lui, Hong Kong (CN); Jing Zhao, Beijing (CN)

(72) Inventors: Ka Cheong Lui, Hong Kong (CN); Jing Zhao, Beijing (CN)

(73) Assignee: Google Inc., Mountain View, CA (US)

(21) Appl. No.: 13/996,069

(22) PCT Filed: Jun. 12, 2012
(86) PCT No.: PCT/CN12/76804

§ 371 Date: Jun. 20, 2013

(51) Int. Cl. G06Q 30/02; G06F 17/30

(52) U.S. Cl. CPC G06Q 30/0256; G06F 17/3053; G06F 17/30598

(57) ABSTRACT

A system includes receiving information regarding a first keyword associated with a user, where the first keyword is usable by a content distribution system to select content for distribution based on keywords associated with the user. The system also includes obtaining an attribute associated with the user; identifying at least one keyword category corresponding to the attribute; and selecting at least one alternative keyword associated with the at least one identified keyword category. The selecting may include consulting a taxonomy database to identify alternative keywords that are relevant to the first keyword. The system also includes ranking the at least one alternative keyword according to a ranking rule associated with the at least one keyword category associated with the at least one alternative keyword; and providing information associated with the ranked at least one alternative keyword to the user for selection by the user.

### BACKGROUND

This disclosure relates generally to obtaining alternatives to input as keywords, e.g., for use in identifying online content, such as advertising.

The Internet provides access to a wide variety of resources. For example, video, audio, and Web pages are accessible over the Internet. These resources present opportunities for other content (e.g., advertising or non-advertising content, such as audio, video, or the like) to be provided with the resources. For example, a Web page can include slots in which content can be presented. Similarly, such slots can be part of television programming.

Slots can be allocated to content providers (e.g., advertisers). In one type of system, a network can be used to allocate content to the slots based, e.g., on various factors relating to the content and the context in which it is to be presented. For example, the content can be allocated based, in part, on keywords input to a system, such as a search engine. An auction can be performed for the right to present advertising in a slot. In the auction, content sponsors provide bids specifying amounts that the content sponsors are willing to pay for presentation of their content. Typically, the winning bidder is given the right to present content.

### SUMMARY

Descried herein is an example system that includes receiving information regarding a first keyword associated with a user, where the first keyword is usable by a content distribution system to select content for distribution based on keywords associated with the user. The system also includes obtaining an attribute associated with the user; identifying at least one keyword category corresponding to the attribute; and selecting at least one alternative keyword associated with the at least one identified keyword category. The selecting may include consulting a taxonomy database to identify alternative keywords that are relevant to the first keyword. The system also includes ranking the at least one alternative keyword according to a ranking rule associated with the at least one keyword category associated with the at least one alternative keyword; and providing information associated with the ranked at least one alternative keyword to the user for selection by the user. The system may include one or more of the following features.

The system may include receiving, from the user, a selection of one or more of the at least one ranked alternative keyword.

The identified keyword categories may include a service industry category that includes service industry groups. Each service industry group may correspond to a service industry and include alternative keywords associated with the service industry. At least one service industry group may be associated with a service industry of the user and other service industry groups may not associated with the service industry of the user. Alternative keywords of at least one service industry group may be ranked according to a relevance of the alternative keywords to the first keyword, according to a popularity of the alternative keywords, according to a cost of the alternative keywords, and/or randomly.

The identified keyword categories may include a relevance category for alternative keywords. The identified keyword categories may include a cost category for alternative keywords.

The information regarding an attribute associated with the user may include information provided by the user. The attribute associated with the user may include at least one of: a description of a product provided by the user, a brand name associated with the user, or information that identifies the user.

The systems described herein, or portions thereof, may be implemented as a computer program product that includes instructions that are stored on one or more machine-readable storage media, and that are executable on one or more processing devices. The systems described herein, or portions thereof, may be implemented as an apparatus, method, or electronic system that may include one or more processing devices and memory to store executable instructions to implement the stated functions.

The details of one or more implementations are set forth in the accompanying drawings and the description below. Other features, objects, and advantages will be apparent from the description and drawings, and from the claims.

### DESCRIPTION OF DRAWINGS

FIG. 1 is a block diagram of an example system for obtaining alternatives to input keywords and for providing online content.

FIG. 2 is a flowchart showing an example process for providing alternatives to an input keyword.

FIG. 3 is an example user interface for providing a keyword for which alternatives are to be determined

FIGS. 4A to 4D are example Web pages showing alternative keywords determined using different criteria.

FIG. 5 shows examples of computing devices on which the processes described herein, or portions thereof, may be implemented.

Like reference symbols in the various drawings indicate like elements.

### DETAILED DESCRIPTION

Described herein are techniques for obtaining alternatives to an input keyword, and for providing those alternatives to a user's computer for selection. More specifically, online content providers, such as advertisers, associate keywords with their content. If a query entered into a search engine matches one or more of those keywords, content associated with those keywords is retrieved and output along with the search results. For example, if the keywords of a search query match keywords associated with online advertising, that advertising may be retrieved and served along with the search results. The processes described herein are used to obtain alternatives to input keywords in order to provide content to more users who may be interested in the content associated with those keywords

The processes described herein may be implemented in any appropriate network environment, with any appropriate devices and computing equipment. An example of such an environment is described below.

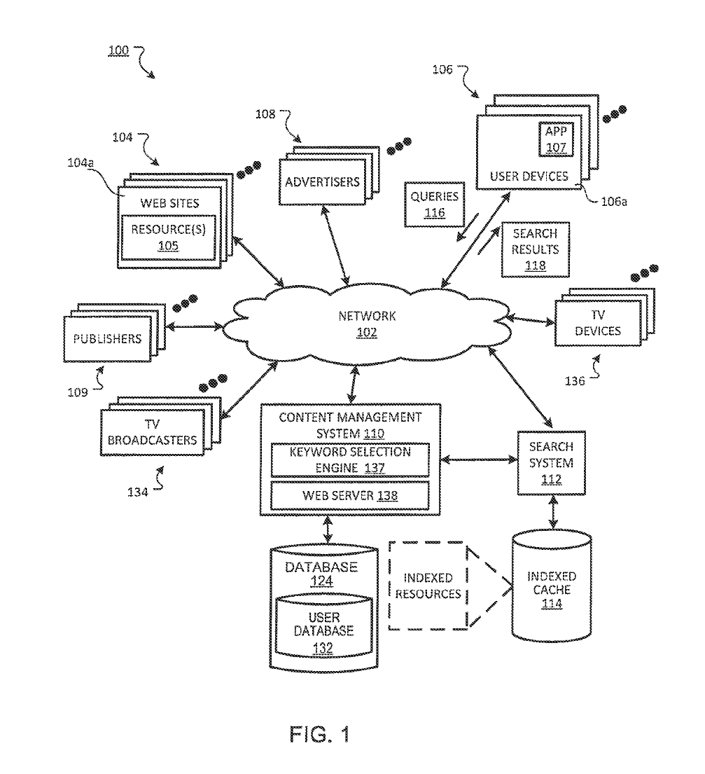

FIG. 1 is a block diagram of an example system 100 for obtaining alternatives to an input keyword, for providing those alternatives to a user's computer for selection, for associating selected keywords with content, and for providing content to a user when user-input keywords match keywords associated with the content. The example system 100 includes a network 102.

Network 102 can represent a communications network that can allow devices, such as a user device 106a, to communicate with entities on the network through a communication interface (not shown), which may include digital signal processing circuitry. Network 102 can include one or more networks. The network(s) may provide for communications under various modes or protocols, such as Global System for Mobile communication (GSM) voice calls, Short Message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, General Packet Radio System (GPRS), or one or more television or cable networks, among others. For example, the communication may occur through a radio-frequency transceiver. In addition, short-range communication may occur, such as using a BLUETOOTH, WiFi, or other such transceiver.

Network 102 connects various entities, such as Web sites 104, user devices 106, content providers (e.g., advertisers 108), online publishers 109, and a content management system 110. In this regard, example environment 100 may include many thousands of Web sites 104, user devices 106, and content providers (e.g., advertisers 108). Entities connected to network 102 include and/or connect through one or more servers. Each such server may be one or more of various forms of servers, such as a Web server, an application server, a proxy server, a network server, or a server farm. Each server can include one or more processing devices, memory, and a storage system.

In FIG. 1, Web sites 104 may include one or more resources 105 associated with a domain name and hosted by one or more servers. An example Web site 104a is a collection of Web pages formatted in hypertext markup language (HTML) that can contain text, images, multimedia content, and programming elements, such as scripts. Each Web site 104 can be maintained by a publisher 109, which is an entity that controls, manages and/or owns the Web site 104.

A resource 105 may be any appropriate data that can be provided over network 102. A resource 105 can be identified by a resource address that is associated with the resource 105. Resources 105 can include HTML pages, word processing documents, portable document format (PDF) documents, images, video, and news feed sources, to name a few. Resources 105 can also include content, such as words, phrases, images, video and sounds, that may include embedded information (such as meta-information hyperlinks) and/or embedded instructions (such as JavaScript scripts).

To facilitate searching of resources 105, environment 100 can include a search system 112 (e.g., a search engine) that identifies the resources 105 by crawling and indexing the resources 105 provided by the content publishers on the Web sites 104. Data about the resources 105 can be indexed based on the resource 105 to which the data corresponds. The indexed and, optionally, cached copies of the resources 105 can be stored in an indexed cache 114.

An example user device 106a is an electronic device that is under control of a user and that is capable of requesting and receiving resources over the network 102. A user device may include one or more processing devices, and may be, or include, a mobile telephone (e.g., a smartphone), a laptop computer, a handheld computer, a tablet computer, a network appliance, a camera, an enhanced general packet radio service (EGPRS) mobile phone, a media player, a navigation device, an email device, a game console, or a combination of any two or more of these data processing devices or other data processing devices. In some implementations, the user device can be included as part of a motor vehicle (e.g., an automobile, an emergency vehicle (e.g., fire truck, ambulance), a bus).

User device 106a can request resources 105 from a Web site 104a. In turn, data representing the resource 105 can be provided to the user device 106a for presentation by the user device 106a. User devices 106 can also submit search queries 116 to the search system 112 over the network 102. A request for a resource 105 or a search query 116 sent from a user device 106 can include an identifier, such as a cookie, identifying the user of the user device.

In response to a search query 116, the search system 112 can access the indexed cache 114 to identify resources 105 that are relevant to the search query 116. The search system 112 identifies the resources 105 in the form of search results 118 and returns the search results 118 to a user device 106 in search results pages. A search result 118 may be data generated by the search system 112 that identifies a resource 105 that is responsive to a particular search query 116, and that includes a link to the resource 105. An example search result 118 can include a Web page title, a snippet of text or a portion of an image extracted from the Web page, and the URL (Unified Resource Location) of the Web page.

Content management system 110 may be used for selecting and providing content in response to requests for content. Content management system 110 also can update database 124 based on activity of a user. In this regard, the database 124 can store a profile for the user which includes, for example, information about past user activities, such as visits to a place or event, past requests for resources 105, past search queries 116, other requests for content, Web sites visited, or interactions with content. In some implementations, the information in database 124 can be derived, for example, from one or more of a query log, an advertisement (“ad”) log, or requests for content. The database 124 can include, for each entry, a cookie identifying the user, a timestamp, an IP (Internet Protocol) address associated with a requesting user device 106, a type of usage, and details associated with the usage.

When a resource 105 or search results 118 are requested by a user device 106, content management system 110 can receive a request for content to be provided with the resource 105 or search results 118. The request for content can include characteristics of one or more “slots” that are defined for the requested resource 105 or search results page. For example, the data representing the resource 105 can include data specifying a portion of the resource 105 or a portion of a user display, such as a presentation location of a pop-up window or a slot of a third-party content site or Web page, in which content can be presented. An example slot is an ad slot. Search results pages can also include one or more slots in which other content items (e.g., ads) can be presented.

Information about slots can be provided to content management system 110. For example, a reference (e.g., URL) to the resource for which the slot is defined, a size of the slot, and/or media types that are available for presentation in the slot can be provided to the content management system 110. Similarly, keywords associated with a requested resource (“resource keywords”) or a search query 116 for which search results are requested can also be provided to the content management system 110 to facilitate identification of content that is relevant to the resource or search query 116. For example, the content management system identifies content, such as advertising, that is associated with keywords that match, or are substantially similar to, the input keywords (e.g., are a variant of the keywords, such as “car” or “cars”). When a match is detected, content management system 110 outputs the corresponding content. The processes described herein, which may be performed by code running on content management system, such as keyword selection engine 137, may be used to generate at least some of those keywords and to associate the content with keywords.

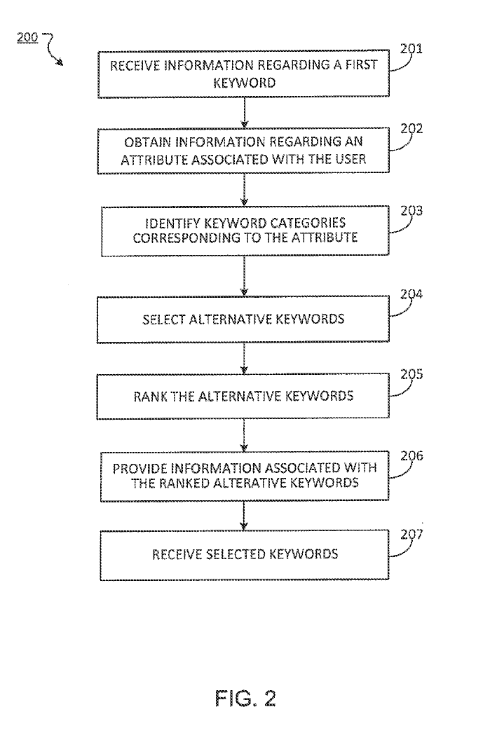

Based at least in part on data included in the request, the content management system 110 can select content that is eligible to be provided in response to the request (“eligible content items”). For example, eligible content items can be eligible ads having characteristics matching the characteristics of ad slots and that are associated with the user-provided keywords (e.g., terms in the input search query), as described below with respect to FIG. 2. The universe of eligible content items (e.g., ads) can be narrowed by taking into account other factors, such as the content of previous search queries 116. For example, content items corresponding to historical search activities of the user including, e.g., search keywords used, particular content interacted with, sites visited by the user, etc. may also be used in the selection of eligible content items by the content management system 110.

Content management system 110 can select the eligible content items that are to be provided for presentation in slots of a resource 105 or search results page 118 based, at least in part, on results of an auction. For example, for eligible content items, content management system 110 can receive bids from content providers (e.g., advertisers 108) and allocate slots, based at least in part on the received bids (e.g., based on the highest bidders at the conclusion of the auction). The bids are amounts that the content providers are willing to pay for presentation (or selection) of their content with a resource 105 or search results page 118. For example, a bid can specify an amount that a content provider is willing to pay for each 1000 impressions (i.e., presentations) of the content item, referred to as an ECPM bid. Alternatively, the bid can specify an amount that the content provider is willing to pay for a selection (i.e., a click-through) of the content item or a conversion following selection of the content item. The selected content item can be determined based on the bids alone, or based on the bids of each bidder being multiplied by one or more factors, such as quality scores derived from content performance, landing page scores, and/or other factors.

As described herein, in some implementations, a content provider can bid for a particular audience of users. For example, one or more of the publishers 109 and/or the content management system 110 may provide one or more audiences of users where each user in the audience matches one or more content serving criteria, such as matching one or more categories of interest. An audience of users may be represented, for example, as a user list. User lists or other representations of audiences may be stored, for example, in a user database 132. A bid from a content provider can specify, for example, an amount that the content provider is willing to pay for each 1000 impressions (i.e., presentations) of the content item to a particular audience of users. The content management system 110 may, for example, manage the presentation of the content item to users included in a particular audience and may manage charging of the content provider for the impressions and distributing revenue to the publishers 109 based on the Impressions.

In some implementations, TV (Television) broadcasters 134 produce and present television content on TV user devices 136, where the television content may be organized into one or more channels. The TV broadcasters 134 may include, along with the television content, one or more content slots in which other content (e.g., advertisements) may be presented. For example, a TV network may sell slots of advertising to advertisers in television programs that they broadcast. Some or all of the content slots may be associated with keywords that relate, e.g., to the television programs in broadcast on a particular channel. Alternatives to those keywords may be obtained according to the processes described herein.

FIG. 2 is a flow chart showing an example process 200 for obtaining alternatives to an input keyword, and for providing those alternatives to a content creator for selection. Process 200 may be performed, e.g., by code, such as keyword selection engine 137, running in content management system 110. In the example described below, the “user” is an advertiser who is associating keywords with advertising content. However, process 200 may be Implemented in connection with any appropriate content provider for any appropriate context by any appropriate entity.

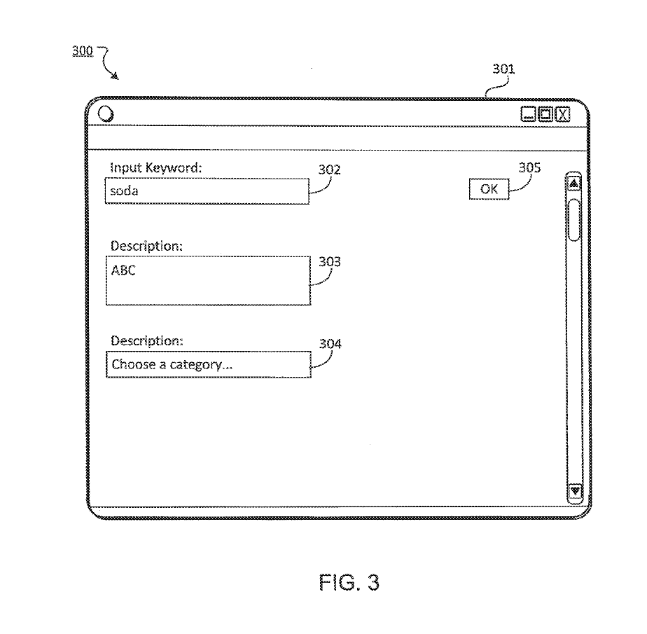

Referring to FIG. 3, in this example, user interface 301 is output to an advertiser's computing device 106a. For example, code for the user interface may be generated by keyword selection engine 137, and a Web server 138 in content management system may output that code to computing device 106a. Computing device 106a uses that code to render user interface 301. In operation, the advertiser inputs a first keyword, along with other information (e.g., the attribute information described below), into field 302 of user interface 301. In other implementations, information about the first keyword may be received into field 302, and that information may be used by keyword selection engine 137 to suggest possible keywords for input into user interface 301.

User interface 301 also includes a control for submitting input, in this example, “OK” button 305. In response to selecting button 305, information input to user interface 301 is transmitted to content management system 110. In response, content management system 110 (e.g., keyword selection engine 137) may perform the processing described herein to suggest alternatives to the first keyword, to receive a user selection of one or more of the alternative keywords, and to associate the selected alternative keywords with advertising content.

Referring back to FIG. 1, according to process 200, information regarding a first user-input keyword (“the first keyword”) is received through user interface 301. For example, keyword selection engine 137 may receive (201) the first keyword from user interface 301 on computing device 106a. The first keyword may be usable to select content (e.g., advertising), as described herein.

In this implementation, the first keyword relates to content, such as advertising, provided by the advertiser. For example, the first keyword may be correlated to content so that, when a searcher provides the keyword to a search system (e.g., search system 112), that keyword may be used to identify advertising provided by the advertiser. In the example of FIG. 3, advertiser may be ABC brand soda company. So, the first keyword input to field 301 is “soda”, which is descriptive of the advertiser's product. Any appropriate keyword may be used. Also, in an alternative implementation, an advertisement service provider may provide the first keyword, and not the advertiser.

In addition to keywords, content service providers may have additional information about themselves or their product, which could be useful in generating keywords. Such information, referred to herein as “user attributes”, may include, e.g., a description of a product or service provided by the advertiser (e.g., “soda”, “beverage”, “refreshing”), a brand name associated with the advertiser (e.g., “ABC”), or any other appropriate information for identifying the product or advertiser.

In the example of FIG. 2, the user attributes are also received through Web page 301. Specifically, the user attributes may be input through description field 303. For example, the advertiser may input a name of, or a description of, a product or service to be advertised, a brand name of the product or service, or any other appropriate information into field 303. In the example of FIG. 3, the advertiser has input a brand name “ABC” in description field 303, e.g., because the advertiser wishes to advertise a soda having brand name “ABC”. In addition, the advertiser may know how its industry is classified, and also provide that information. In this example, the advertiser may know that it is part of the beverage industry, and classify itself accordingly on Web page 301.

Referring back to FIG. 1, information relating to user attributes, such as those described above, is obtained (202). For example, keyword selection engine 137 may receive the user attributes from Web page 301. Alternatively, keyword selection engine 137 may retrieve the user attributes from other source(s), such as the Internet or from a database associated with content management system 110.

Keyword categories corresponding to the user attribute are also identified (203). A keyword category may be provided (e.g., selected) by the advertiser using field 304 of user interface 301. Alternatively, the keyword category may be selected automatically by keyword selection engine 137 based on prior knowledge of the advertiser or other appropriate information.

The keyword categories may be categories that encompass, or describe, a user attribute generally. For example, for a soda manufacturer, such as a manufacturer of ABC brand soda, the keyword category may be “beverage industry”, since the advertiser is a producer of beverages, or “service industry” since the advertiser is a purveyor of beverages. Each keyword category may include one or more sub-categories. For example, the service industry category may include keywords that correspond to a variety of service industries. For example, for a soda manufacturer having a brand name “ABC”, a variety of service industries including “Beverages”, “Food”, “Sports”, etc. may be identified. In each of these representative service industries, there may be keywords that can be used to describe the advertiser's product (in this example, “soda”). Keywords may be ranked based on factors, such as relevance, popularity, and cost.

According to process 200, alternative keywords are selected (204) from among the identified keyword categories. For example, keyword selection engine 137 may select the alternative keywords. The alternative keywords are selected based, e.g., on input user attribute(s) and on the first keyword. For example, a taxonomy may be consulted to identify keyword(s) that are relevant to the first keyword and that have, e.g., identifiable costs and popularities. Similarly, a taxonomy may be consulted to identify keywords associated with the user attributes (e.g., associated with the brand name, and so forth). The taxonomy may be stored in memory in a database and appropriately indexed for consultation. In an example, implementation, alternative keywords may be selected that have some relation, or that relate to products, services, or concepts that may have some relation (e.g., are often used together). For example, if the first keyword is “soda” or “beer”, alternative keywords such as “football”, “basketball”, “NFL”, etc. may be selected. Those alternative keywords may seem, on their face, to have no relation with the original keyword. However, in many cases, people associate soda or beer with watching or participating in the above sporting events/activities.

According to process 200, the selected alternative keywords are ranked (205) according to one or more ranking rules associated with the corresponding keyword categories. One reason for ranking selected alternative keywords is to enable advertisers to locate desired keywords in different ways. For example, small and medium advertisers may identify inexpensive, but popular, keywords having a certain degree of relevance using ranking rules. In an example, some keywords are not ranked at the top of a word list for one ranking rule, but are ranked at the top of a word list for another ranking rule. Such advertisers may select those words or words that are not at the top of the word list in any ranking rule. Generally, a certain rank in any ranking rule may be enough for an advertiser to select a particular keyword.

The one or more ranking rules may reflect of a degree of relevance to the first keyword, a degree of popularity of the alternative keyword(s), or a cost to use/purchase the alternative keywords, among other things. The rankings may be highest to the lowest or lowest to the highest. The ranking rules may also rank alternative keywords according to a random sequence so that a keyword that is not most popular or not most relevant may be ranked at a top of the list of alternative keywords in a category, from which a user can select that keyword. The ranking rule(s) may be selected, e.g., by the user or content management system 110.

According to process 110, information associated with the ranked alternative keywords is output (206) to the user's computer. The information may relate to the alternative keywords, which the user may select for use with their advertising. In particular, the information may include code for a user interface that may be generated by keyword selection engine 137, and a Web server 138 in content management system may output that code to computing device 106a. Computing device 106a may use that code to render a user interface, such as those described herein, containing the alternative keywords, and from which the user may select one or more such keywords.

In response to user selection of alternative keyword(s), information is received (207) by content management system 110 identifying which alternative keywords have been selected. Content management system 110 associates the selected keyword(s) with the advertiser's content. Thus, when those keywords are input, e.g., to a system 112, advertising corresponding to those alternative keywords may be retrieved and output for display along with content provided with the search results. The advertising may be displayed, e.g., on a search results page or on individual pages selected from that search results page (e.g., in one or more slots on those pages).

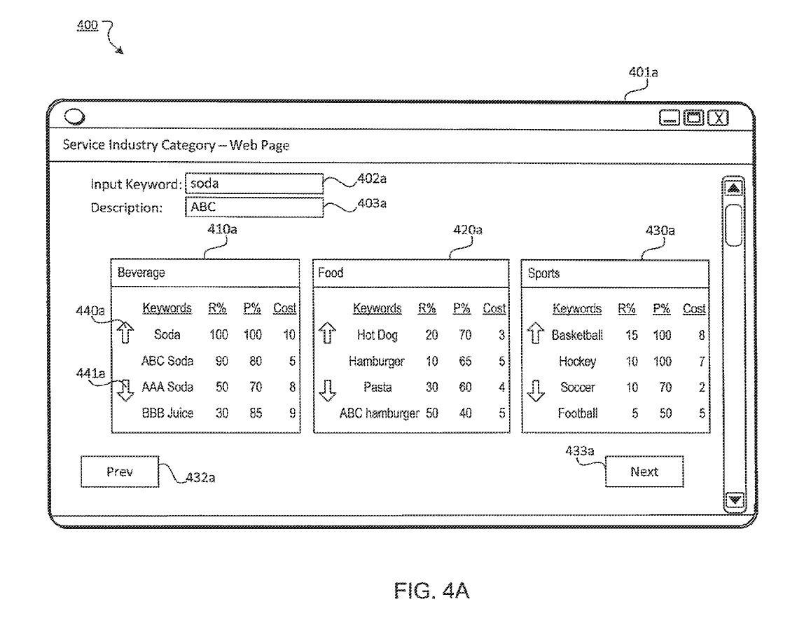

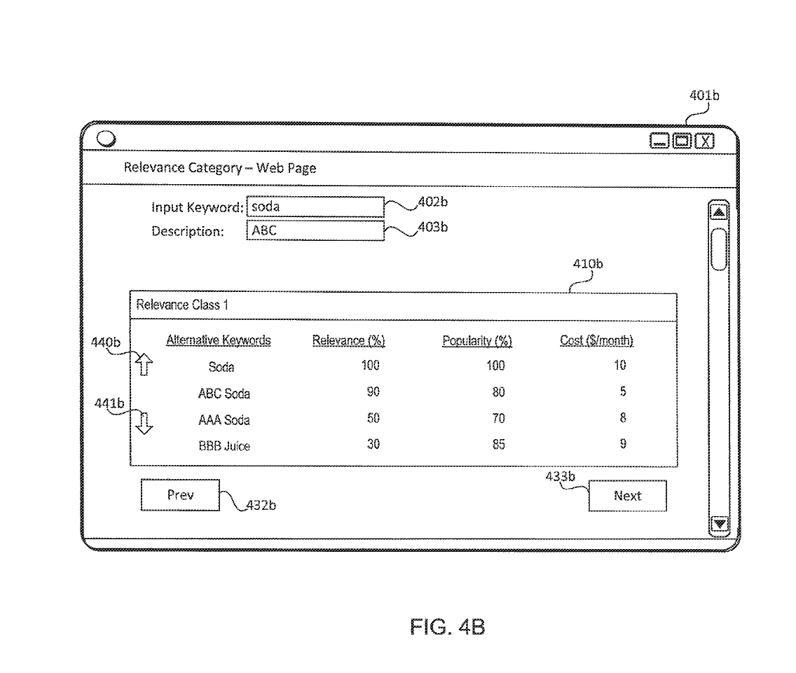

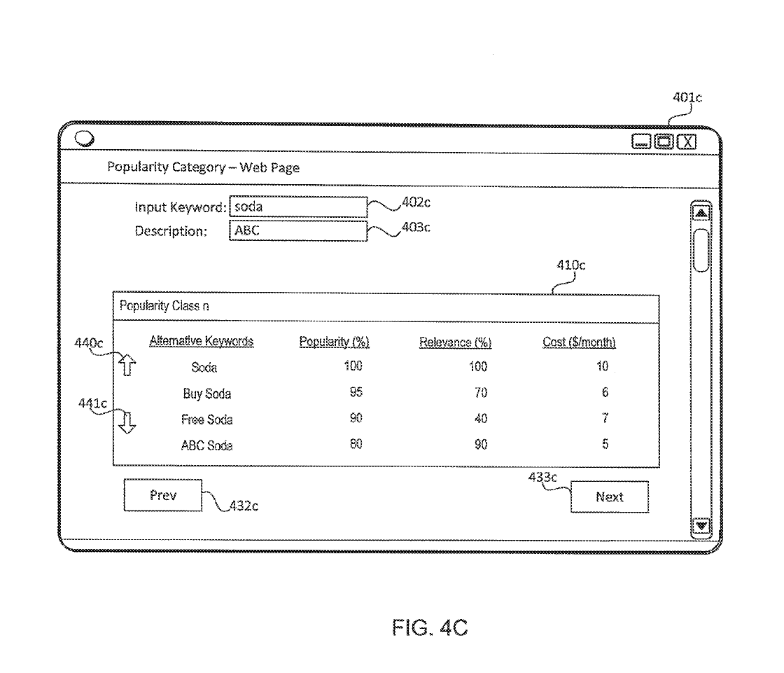

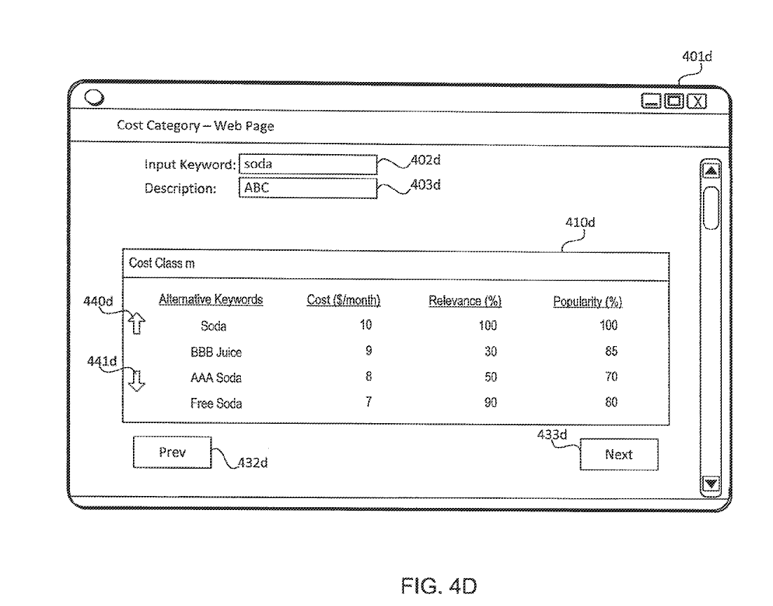

FIGS. 4A to 4D show examples of Web pages that display alternative keywords ranked by the processes described herein according to one or more criteria. FIG. 4A shows an example output for an input “service industry” attribute. More specifically, when the advertiser selects a “service industry” in field 304 of FIG. 3 and clicks “OK” button 305, content management system 110 performs process 200 to output code for generating Web page 401a. Web page 401a shows a first keyword 402a, and a description 403a of the advertiser or the product.

In the example of FIG. 4A, three different service industry groups are shown. Each of these service industry groups corresponds to a service industry and contains alternative keywords and information associated with the alternative keywords. The corresponding service industries shown in Web page 401a include Beverage 410a, Food 420a, and Sports 430a. By clicking “Prev” or “Next” buttons 432a, 433a, an advertiser can view more service industry groups (if any).

In “Beverage” service industry group 410a, alternative keywords associated with the beverage industry are provided. In this regard, a soda manufacturer is part of the beverage industry. Accordingly, in this example, “Beverage” service industry group 410a is associated with the advertiser's service industry. Web page 401a provides, on the right side of each alternative keyword in this example, reference information, such as its degree of relevance to the first keyword, its degree of popularity, and its cost. By selecting (e.g., clicking on) underlined titles associated with the degree of relevance (“R %”), the degree of popularity (“P %”), and the cost (“Cost”), the alternative keywords are ranked according to the corresponding underlined title (e.g., according to relevance, popularity or cost). Additionally, by selecting an underlined title of alternative keywords (“Keywords”), the alternative keywords are ranked randomly. By clicking a UP or DOWN arrows 440a, 440b, the advertiser can view more alternative keywords in “Beverage” service industry group 410a.

In “Food” service industry group 420a, alternative keywords associated with the food industry are provided. In this regard, a soda manufacturer is part of the beverage industry and not, strictly speaking, the food industry. However, the food market may be an important market for beverages, such as soda. Therefore, even though the two service industries are different, it is possible that a soda manufacturer might find effective keywords from the “Food” service industry group. Accordingly, alternative keywords from that service group are listed. Web page 401a provides, on the right side of each alternative keyword in this example, reference information, such as its degree of relevance to the first keyword, its degree of popularity, and its cost. By clicking underlined titles of degree of relevance (“R %”), degree of popularity (“P %”), and cost (“Cost”), the alternative keywords can be ranked according to the corresponding underlined title. Additionally, by clicking an underlined title of the alternative keywords (“Keywords”), the alternative keywords can be ranked randomly. By clicking UP or DOWN arrows 440a, 441a, the advertiser can view more alternative keywords from “Food” service industry group 420a.

In “Sports” service industry group 430a, alternative keywords associated with the sports industry are provided. In this regard, a soda manufacturer is part of the beverage industry and not the sports service industry. However, the sports market may be an important market for beverages, such as soda. Therefore, even though the two service industries are different, it is possible that a soda manufacturer might find effective keywords from the “Sports” service industry. Accordingly, alternative keywords from that service group are listed. Web page 401a provides, on the right side of each alternative keyword in this example, reference information, such as its degree of relevance to the first keyword, its degree of popularity, and its cost. By clicking underlined titles of degree of relevance (“R %”), degree of popularity (“P %”), and cost (“Cost”), the alternative keywords can be ranked according to the underlined title. Additionally, by clicking an underlined title of the alternative keywords (“Keywords”), the alternative keywords can be ranked randomly. By clicking UP or DOWN arrows 440a, 441a, the advertiser can view more alternative keywords in “Sports” service industry group 430a.

FIG. 4B shows an example output for a “relevance category” input. More specifically, when the advertiser selects the “relevance category” in field 304 of FIG. 3 and clicks “OK” button 305, content management system 110 performs process 200 to output code for generating Web page 401b. Web page 401b shows first keyword 402b and a description of the advertiser at 403b.

In the example of FIG. 4B, alternative keywords are ranked primarily (although not necessarily solely) according to a relevance of the alternative keywords to the first keyword. Primary ranking is indicated by closeness of the “relevance” column to the alternative keywords, relative to the “popularity” and “cost” columns. The ranked alternative keywords are grouped and displayed in different class groups based on their degree of relevance to the first keyword. For example, in FIG. 4B, a class of alternative keywords with the highest degree of relevance is shown, and referred to as “Relevance Class 1” group 410b.

“Relevance Class 1” group 410b includes alternative keywords with a highest degree of relevance to the first keyword. Web page 401b provides, on the right side of each alternative keyword in this example, reference information, such as its degree of relevance to the first keyword, its degree of popularity, and its cost. By clicking underlined titles for, e.g., degree of popularity (“Popularity (%)”) and cost (“Cost ($/month)”), the alternative keywords can be ranked according to their corresponding underlined title. Additionally, by clicking an underlined title of the alternative keywords (“Alternative Keywords”), the alternative keywords can be ranked randomly. Popularity and cost rankings in the Class 1 group may be secondary rankings, at least compared with the relevance ranking. This is indicated, in Web page 401b, by the distance of the popularity and cost columns from the keyword column relative to the relevance column.

By clicking UP or DOWN arrows 440b, 441b, the advertiser can view more alternative keywords in “Relevance Class 1” group 410b. By clicking on a “Prev” or “Next” button 432b, 433b in Web page 401b, the advertiser can view more class groups (if any). For example, although “Relevance Class 1” group is shown in FIG. 4B, by clicking “Next” button 433b, the advertiser may view other such class groups such as “Relevance Class 2”, “Relevance Class 3” (less relevant), and so forth in order of decreasing relevance. In this example, the degree of relevance is ranked from highest to lowest, respectively, in “Class 1”, “Class 2”, “Class 3”, etc. Alternatively, degree of relevance may be ranked from lowest to highest. In this case, the alternative keywords contained in “Relevance Class 1” are keywords with little or no relevance to the first keyword. However, an advertiser may still obtain desired keyword(s) from among alternative keywords in “Relevance Class 1”.

By virtue of the foregoing system, it is possible for an advertiser to obtain a keyword having a relatively high degree of relevance and a medium/low degree of popularity, a keyword with a high relevance and a medium/low cost, and so forth.

FIG. 4C shows an example output for a “popularity category” input. More specifically, when the advertiser selects the “popularity category” in field 304 of FIG. 3 and clicks “OK” button 305, content management system 110 performs process 200 to output code for generating Web page 401c. Web page 401c shows first keyword 402c, and a description of the advertiser at 403c.

In the example of FIG. 4C, alternative keywords are ranked primarily (but not necessarily solely) according to a popularity of the alternative keywords. Popularity may be determined, e.g., from Web search logs or other appropriate information databases. The ranked alternative keywords are displayed in different class groups based on their degree of popularity. For example, in FIG. 4C, a class of alternative keywords with the highest degree of popularity is shown, and referred to as “Popularity Class n” group 410c.

In the “Popularity Class n” group 410c, alternative keywords having a degree of popularity are provided. Web page 401c provides, on the right side of each alternative keyword in this example, reference information, such as its degree of relevance to the first keyword, its degree of popularity, and its cost. By clicking underlined titles of degree of relevance (“Relevance (%)”) and cost (“Cost (S/month)”), the advertiser can rank the alternative keywords according to the corresponding underlined title. Additionally, by clicking underlined titles of the alternative keywords (“Alternative Keywords”), the alternative keywords can be ranked randomly. Relevance and cost ranking in the Class n group may be secondary rankings, at least compared with the popularity ranking. By clicking UP or DOWN arrows 440c, 441c, the advertiser can view more alternative keywords in the “Popularity Class n” group 410c.

By clicking on a “Prev” or “Next” button 432c, 433c in Web page 401c, the advertiser can view more class groups (if any). For example, although “Popularity Class n” group is shown in FIG. 4C, by clicking “Next” button 433c, the advertiser may view other class groups such as such as “Popularity Class n−1” (more popular), “Popularity Class n+1” (less popular), and so forth. In the foregoing example, degree of popularity is ranked from highest to lowest, respectively, in “Class n−1”, “Class n”, “Class n+1”, and so forth. Alternatively, degree of popularity may be ranked from lowest to highest. In this case, the alternative keywords contained in “Popularity Class 1” are keywords with little or no relevance to the first keyword. However, an advertiser may still obtain effective keyword(s) from among alternative keywords in “Relevance Class 1”.

By virtue of the foregoing system, it may be possible for an advertiser to obtain a keyword having a relatively high degree of popularity and a medium/low degree of relevance, a keyword with a high popularity and a medium/low cost, and so forth.

FIG. 4D shows an example output for a “cost category” input. More specifically, when the advertiser selects the “cost category” in field 304 of FIG. 3 and clicks “OK” button 305, content management system 110 performs process 200 to generate Web page 401d. Web page 401d shows first keyword 402d, and a description of the advertiser at 403d.

In the example of FIG. 4D, alternative keywords are ranked primarily (although not necessarily solely) according to a cost of the alternative keywords (e.g., how much it would cost to use the corresponding keyword). The ranked alternative keywords are displayed in different class groups based on their cost. Content management system 110 may set the cost of each keyword, or obtain the cost from elsewhere. For example, in FIG. 4D, a class of alternative keywords with a certain cost is shown, and referred to as “Cost Class m” group 410d.

In “Cost Class m” group 410d, alternative keywords with a certain cost level are provided. Web page 401d provides, on the right side of each alternative keyword in this example, reference information, such as its degree of relevance to the first keyword, its degree of popularity, and its cost. By clicking underlined titles of degree of relevance (“Relevance (%)”) and degree of popularity (“Popularity (%)”), alternative keywords can be ranked according to their corresponding underlined title. Additionally, by clicking an underlined title of the alternative keywords (“Alternative Keywords”), the alternative keywords can be ranked randomly. Relevance and popularity ranking in the Class m group may be secondary rankings, at least compared with the cost ranking. By clicking UP or DOWN arrows 440d, 441d, the advertiser can view more alternative keywords in “Cost Class m” 410b.

By clicking on a “Prev” or “Next” button 432d, 433d in Web page 401d, the advertiser can view more class groups (if any). For example, although “Cost Class m” group is shown in FIG. 4D, by clicking “Next” button 433d, the advertiser may continuously view other class groups such as Cost Class m−1” group (cheaper), “Cost Class m+1” group (more expensive), and so forth in an order of decreasing cost. In the foregoing example, cost is ranked from highest to lowest, respectively, in “Class m−1”, “Class m”, “Class m+1”, etc. Alternatively, cost may be ranked from lowest to highest. In this case, the alternative keywords contained in “Cost Class 1” are least expensive. However, an advertiser may still obtain effective keyword(s) from among alternative keywords in “Cost Class 1”.

By virtue of the foregoing system, it is possible for an advertiser to obtain a keyword that is relatively inexpensive, and that has a certain relevance and/or a certain degree of popularity.

In the implementations described herein, the ranked alternative keywords are displayed in a Web page for selection. In alternative implementations, the ranked alternative keywords may be transmitted by mail, electronic mail (e-mail), mobile messaging, or the any other appropriate delivery system, whether electronic or manual. In addition, in the implementations described herein, ranking rules may be selected by the user. In alternative implementations, the ranking rules may be established/selected by service providers, after which the ranking rule may be identified to the user (e.g., in a Web page display).

In the implementations described herein, the information associated with the alternative keywords includes relevance, popularity, and cost. However the reference information may include other information that may have an effect on a content provider's description of keywords, such as historical usage of keywords, original meaning and extending meanings of keywords, and so forth. Furthermore, those types of information may form bases for ranking rules.

In the implementations described herein, keyword categories include service industry, relevance, popularity, and cost. However, keyword categories may include other categories that have an effect on a content provider's description of keywords, such as historical usage of the keywords, original meaning and extending meanings of the keywords, and so forth. Furthermore, those types of information may form bases for ranking rules.

In the implementations described herein, degree of popularity of a keyword can be obtained from statistics based on a number of clicks corresponding to the keyword during a specified period. The cost of the keyword may be an actual cost that was bid by other advertisers or an estimated cost based on the click amount, usage historical information, and other similar factors. The keywords and the associated information can be updated in real-time or periodically. In the example described above, ABC soda may be allowed to bid for a keyword that includes a competitor's trademark provided it is permitted by law and by policy.

Although the implementations are described for a soda manufacturer, the processes described herein may be used with any appropriate manufacturer.

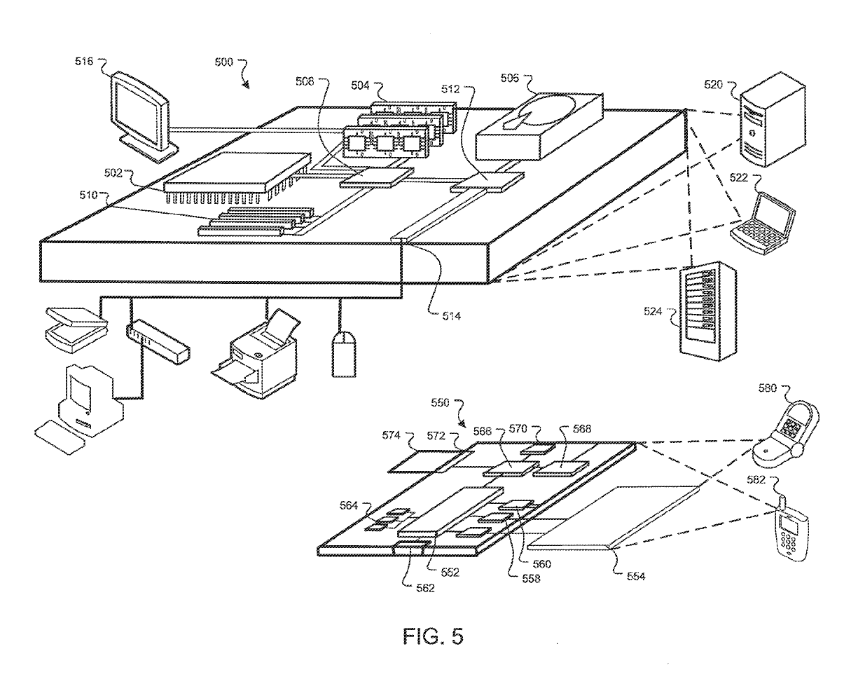

FIG. 5 shows an example of a generic computing device 500 and a generic mobile computing device 550, which may be used to implement all or part of the processes described herein. For example, the content management system 110 and the search system 112 may be implemented by computing device 500 and mobile computing device 550 may implement a user device 106/106a of FIG. 1. Computing device 500 is intended to represent various forms of digital computers, e.g., laptops, desktops, workstations, personal digital assistants, servers, blade servers, mainframes, and other appropriate computers. Computing device 550 is intended to represent various forms of mobile devices, e.g., personal digital assistants, cellular telephones, smartphones, and other similar computing devices. The components shown here, their connections and relationships, and their functions, are meant to be examples, and are not meant to limit the implementations described and/or claimed in this document.

Computing device 500 is intended to represent various forms of digital computers, examples of which include laptops, desktops, workstations, personal digital assistants, servers, blade servers, mainframes, and other appropriate computers. Computing device 550 is intended to represent various forms of mobile devices, examples of which include personal digital assistants, cellular telephones, smartphones, and other similar computing devices. The components shown here, their connections and relationships, and their functions, are meant to be examples, and are not meant to limit the scope of the appended claims.

Computing device 500 includes a processor 502, memory 504, a storage device 506, a high-speed interface 508 connecting to memory 504 and high-speed expansion ports 510, and a low speed interface 512 connecting to low speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, for example, display 516 coupled to high speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a volatile memory unit or units. In another implementation, the memory 504 is a non-volatile memory unit or units. The memory 504 may also be another form of computer-readable medium, examples of which include a magnetic or optical disk.

The storage device 506 is capable of providing mass storage for the computing device 500. In one implementation, the storage device 506 may be or contain a computer-readable medium, for example, a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, including those described above. The information carrier may be a computer- or machine-readable medium, for example, the memory 504, the storage device 506, memory on processor 502, or a propagated signal. The computer- or machine-readable storage medium does not include a transitory signal.

The high speed controller 508 manages bandwidth-intensive operations for the computing device 500, while the low speed controller 512 manages lower bandwidth-intensive operations. Such allocation of functions is an example. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth, Ethernet, wireless Ethernet) may be coupled to one or more input/output devices, examples of which include a keyboard, a pointing device, a scanner, or a networking device, for example, a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer, for example, a laptop computer 522. Alternatively, components from computing device 500 may be combined with other components in a mobile device (not shown), for example, device 550. Each of such devices may contain one or more of computing device 500, 550, and an entire system may be made up of multiple computing devices 500, 550 communicating with each other.

Computing device 550 includes a processor 552, memory 564, an input/output device for example, a display 554, a communication interface 566, and a transceiver 568, among other components. The device 550 may also be provided with a storage device, for example, a microdrive or other device, to provide additional storage. Each of the components 550, 552, 564, 554, 566, and 568, are interconnected using various buses, and several of the components may be mounted on a common motherboard or in other manners as appropriate.

The processor 552 can execute instructions within the computing device 550, including instructions stored in the memory 564. The processor may be implemented as a chipset of chips that include separate and multiple analog and digital processors. The processor may provide, for example, for coordination of the other components of the device 550, for example, control of user interfaces, applications run by device 550, and wireless communication by device 550.

Processor 552 may communicate with a user through control interface 558 and display interface 556 coupled to a display 554. The display 554 may be, for example, a TFT LCD (Thin-Film-Transistor Liquid Crystal Display) or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provide in communication with processor 552, so as to enable near area communication of device 550 with other devices. External interface 562 may provide, for example, for wired communication in some implementations, or for wireless communication in other implementations, and multiple interfaces may also be used.

The memory 564 stores information within the computing device 550. The memory 564 can be implemented as one or more of a computer-readable medium or media, a volatile memory unit or units, or a non-volatile memory unit or units. Expansion memory 574 may also be provided and connected to device 550 through expansion interface 572, which may include, for example, a SIMM (Single In Line Memory Module) card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provide as a security module for device 550, and may be programmed with instructions that permit secure use of device 550. In addition, secure applications may be provided by the SIMM cards, along with additional information, for example, placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, examples of which include those described above. The information carrier is a computer- or machine-readable medium, for example, the memory 564, expansion memory 574, memory on processor 552, or a propagated signal that may be received, for example, over transceiver 568 or external interface 562.

Device 550 may communicate wirelessly through communication interface 566, which may include digital signal processing circuitry where necessary. Communication interface 566 may provide for communications under various modes or protocols, examples of which include GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, for example, using a Bluetooth, Wi-Fi, or other such transceiver (not shown). In addition, GPS (Global Positioning System) receiver module 570 may provide additional navigation- and location-related wireless data to device 550, which may be used as appropriate by applications running on device 550.

Device 550 may also communicate audibly using audio codec 560, which may receive spoken information from a user and convert it to usable digital information. Audio codec 560 may likewise generate audible sound for a user, for example, through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, as shown in the figure. For example, it may be implemented as a cellular telephone 580. It may also be implemented as part of a smartphone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to a computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be a form of sensory feedback (e.g., visual feedback, auditory feedback, or tactile feedback); and input from the user can be received in a form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or a combination of such back end, middleware, or front end components. The components of the system can be interconnected by a form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

For situations in which the systems discussed herein collect personal information about users, the users may be provided with an opportunity to opt in/out of programs or features that may collect personal information (e.g., information about a user's preferences or a user's current location). In addition, certain data may be anonymized in one or more ways before it is stored or used, so that personally identifiable information is removed. For example, a user's identity may be anonymized.

Elements of different implementations described herein may be combined to form other implementations not specifically set forth above. Elements may be left out of the processes, computer programs, Web pages, etc. described herein without adversely affecting their operation. In addition, the logic flows depicted in the figures do not require the particular order shown, or sequential order, to achieve desirable results. Various separate elements may be combined into one or more individual elements to perform the functions described herein.

Other implementations not specifically described herein are also within the scope of the following claims.

What is claimed is:

1. A method comprising:
receiving information regarding a first keyword associated with a user, the first keyword being usable by a content distribution system to select content for distribution based on keywords associated with the user, the content distribution system comprising one or more processing devices;
obtaining an attribute associated with the user;
identifying at least one keyword category corresponding to the attribute;
selecting at least one alternative keyword associated with the at least one identified keyword category, wherein selecting comprises consulting a taxonomy database to identify alternative keywords that are relevant to the first keyword;
ranking the at least one alternative keyword according to a ranking rule associated with the at least one keyword category associated with the at least one alternative keyword; and
providing information associated with the ranked at least one alternative keyword to the user for selection by the user.

2. The method of claim 1, further comprising:
receiving, from the user, a selection of one or more of the at least one ranked alternative keyword.

3. The method of claim 1, wherein:
the identified keyword categories comprise a service industry category comprising service industry groups;
each service industry group corresponds to a service industry and comprises alternative keywords associated with the service industry, and
at least one service industry group is associated with a service industry of the user and other service industry groups are not associated with the service industry of the user.

4. The method of claim 3, wherein alternative keywords of at least one service industry group are ranked according to a relevance of the alternative keywords to the first keyword.

5. The method of claim 3, wherein alternative keywords of at least one service industry group are ranked according to a popularity of the alternative keywords.

6. The method of claim 3, wherein alternative keywords of at least one service industry group are ranked according to a cost of the alternative keywords.

7. The method of claim 3, wherein alternative keywords of at least one service industry group are ranked randomly.

8. The method of claim 1, wherein the identified keyword categories comprise a relevance category for alternative keywords.

9. The method of claim 1, wherein the identified keyword categories comprise a cost category for alternative keywords.

10. The method of claim 1, wherein the information regarding an attribute associated with the user comprises information provided by the user.

11. The method of claim 1, wherein the attribute associated with the user comprises at least one of: a description of a product provided by the user, a brand name associated with the user, or information that identifies the user.

12. One or more machine-readable media storing instructions that are executable by one or more processing devices to perform operations comprising:
receiving information regarding a first keyword associated with a user, the first keyword being usable to select content for distribution based on keywords associated with the user;
obtaining an attribute associated with the user;
identifying at least one keyword category corresponding to the attribute;
selecting at least one alternative keyword associated with the at least one identified keyword category, wherein selecting comprises consulting a taxonomy database to identify alternative keywords that are relevant to the first keyword;
ranking the at least one alternative keyword according to a ranking rule associated with the at least one keyword category associated with the at least one alternative keyword; and
providing information associated with the ranked at least one alternative keyword to the user for selection by the user.

13. The one or more machine-readable media of claim 12, wherein the operations further comprise:
receiving, from the user, a selection of one or more of the at least one ranked alternative keyword.

14. The one or more machine-readable media of claim 12, wherein:
the identified keyword categories comprise a service industry category comprising service industry groups;
each service industry group corresponds to a service industry and comprises alternative keywords associated with the service industry, and
at least one service industry group is associated with a service industry of the user and other service industry groups are not associated with the service industry of the user.

15. The one or more machine-readable media of claim 14, wherein alternative keywords of at least one service industry group are ranked according to a relevance of the alternative keywords to the first keyword.

16. The one or more machine-readable media of claim 14, wherein alternative keywords of at least one service industry group are ranked according to a popularity of the alternative keywords.

17. The one or more machine-readable media of claim 14, wherein alternative keywords of at least one service industry group are ranked according to a cost of the alternative keywords.

18. The one or more machine-readable media of claim 14, wherein alternative keywords of at least one service industry group are ranked randomly.

19. The one or more machine-readable media of claim 12, wherein the identified keyword categories comprise a relevance category for alternative keywords.

20. The one or more machine-readable media of claim 12, wherein the identified keyword categories comprise a cost category for alternative keywords.

21. The one or more machine-readable media of claim 12, wherein the information regarding an attribute associated with the user comprises information provided by the user.

22. The one or more machine-readable media of claim 12, wherein the attribute associated with the user comprises at least one of: a description of a product provided by the user, a brand name associated with the user, or information that identifies the user.

23. A content management system comprising:
a database storing a taxonomy that indexes keywords to alternatives;
a Web server to provide Web pages for use in receiving keywords; and
a keyword selection engine programmed to perform operations comprising:
receiving, through a Web page, information regarding a first keyword associated with a user, the first keyword being usable to select content for distribution based on keywords associated with the user;
obtaining an attribute associated with the user;
identifying at least one keyword category corresponding to the attribute;
selecting at least one alternative keyword associated with the at least one identified keyword category, wherein selecting comprises consulting a taxonomy to identify alternative keywords that are relevant to the first keyword; and
ranking the at least one alternative keyword according to a ranking rule associated with the at least one keyword category associated with the at least one alternative keyword;
wherein the Web server is programmed to provide information associated with the ranked at least one alternative keyword to the user for selection by the user.

24. The content management system of claim 23, wherein the operations further comprise:
receiving, from the user, a selection of one or more of the at least one ranked alternative keyword.

25. The content management system of claim 23, wherein:
the identified keyword categories comprise a service industry category comprising service industry groups;
each service industry group corresponds to a service industry and comprises alternative keywords associated with the service industry, and
at least one service industry group is associated with a service industry of the user and other service industry groups are not associated with the service industry of the user.

26. The content management system of claim 25, wherein alternative keywords of at least one service industry group are ranked according to a relevance of the alternative keywords to the first keyword.

27. The content management system of claim 25, wherein alternative keywords of at least one service industry group are ranked according to a popularity of the alternative keywords.

28. The content management system of claim 25, wherein alternative keywords of at least one service industry group are ranked according to a cost of the alternative keywords.

29. The content management system of claim 25, wherein alternative keywords of at least one service industry group are ranked randomly.

30. The content management system of claim 23, wherein the identified keyword categories comprise a relevance category for alternative keywords.

31. The content management system of claim 23, wherein the identified keyword categories comprise a cost category for alternative keywords.

32. The content management system of claim 23, wherein the information regarding an attribute associated with the user comprises information provided by the user.

33. The content management system of claim 23, wherein the attribute associated with the user comprises at least one of: a description of a product provided by the user, a brand name associated with the user, or information that identifies the user.
